(19) United States
(12) Patent Application Publication
(10) Pub. No.: US 2008/0055054 A1
(43) Pub. Date: Mar. 6, 2008

(54) METHOD AND APPARATUS FOR INDICATING STATUS OF DISPLAY DEVICE AND PROGRAM INFORMATION BY GENERATING AUDIO SIGNAL

(76) Inventors: Hsu-Jung Tung, Kao-Hsiung City (TW); Tzuo-bo Lin, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/847,342

(22) Filed: Aug. 30, 2007

(30) Foreign Application Priority Data
Aug. 30, 2006 (TW) 095131968

(51) Int. Cl. G08B 3/00

(52) U.S. Cl. 340/384.73; 340/384.7

(57) ABSTRACT

A method is disclosed for indicating hardware statuses of a display device. The method includes detecting a predetermined signal received by the display device for generating a detecting result, generating an audio signal according to the detecting result, and outputting the audio signal. An apparatus thereof includes a detecting unit, a control unit, and an output unit. The detecting unit is used for detecting a predetermined signal received by the display device to generate a detecting result. The control unit is coupled to the detecting unit for generating an audio signal according to the detecting result. The output unit is coupled to the control unit for outputting the audio signal.

### BACKGROUND OF THE INVENTION

1. Field of the Invention

The present invention relates to a display device, and more particularly, to a method and apparatus for indicating status of the display device and program information received by the display device by generating an audio signal.

2. Description of the Prior Art

At present, operational statuses of display equipments such as CRT monitors, LCD monitors, LCD TVs, or digital TVs are displayed by on-screen display, or OSD, during setting. A warning message such as “no signal” is shown on the screen of display devices, such as computer monitors or overhead projectors, when their input signal source is unplugged. In addition, a warning is provided by displaying a classification aphorism at corners of a frame when switching to certain restricted programs, such as those containing scenes with nudity or violence. In other words, when a need to remind or warn the users rises, this is performed in currently available display devices by showing specific images on the screen of the display device. However, during practical usage, the actual situation may prove that such visual reminder or warning on the operational status or program information is neither helpful nor convenient for users, and reminder or warning may not effect.

### SUMMARY OF THE INVENTION

It is therefore an objective of the present invention to provide a display device and method for indicating an operation status, a hardware status, and/or program information by using audible sound, to provide users with more convenience when using the display device.

The claimed invention provides a method for indicating hardware statuses of a display device. The method includes detecting a predetermined signal received by the display device to generate a detecting result, generating an audio signal according to the detecting result, and outputting the audio signal.

The claimed invention provides an apparatus for indicating hardware statuses of a display device. The apparatus includes a detecting unit, a control unit, and an output unit. The detecting unit is used for detecting a predetermined signal received by the display device to generate a detecting result. The control unit is coupled to the detecting unit for generating an audio signal according to the detecting result. The output unit is coupled to the control unit for outputting the audio signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of an apparatus capable of indicating an operation status, a hardware status, and/or program information of a display device according to a first embodiment of the present invention.

FIG. 2 is a block diagram of an apparatus for indicating an operation status, a hardware status, and/or program information of a display device by using a host computer according to a second embodiment of the present invention.

### DETAILED DESCRIPTION

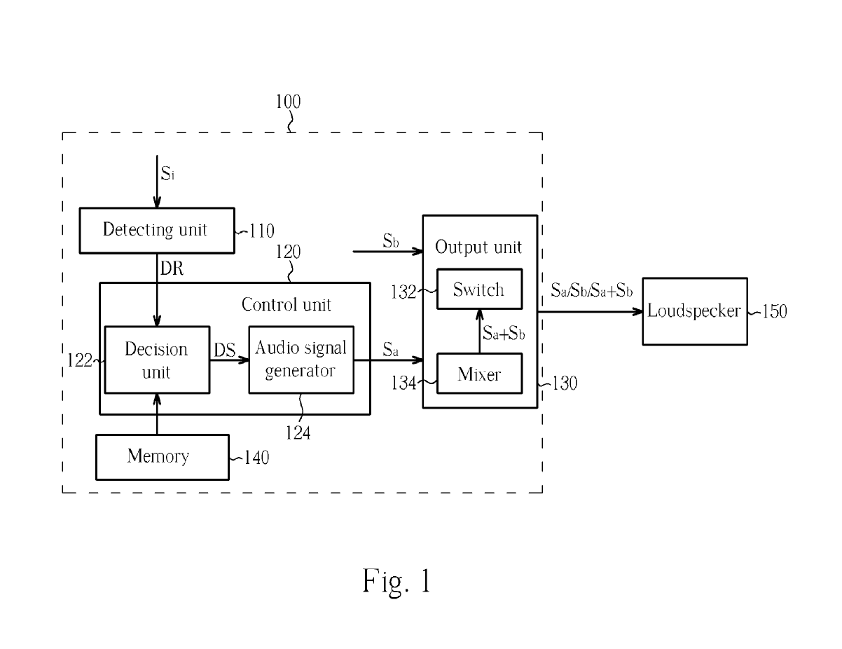

Please refer to FIG. 1. FIG. 1 is a block diagram of an apparatus 100 capable of indicating an operation status, a hardware status, and/or program information of a display device according to a first embodiment of the present invention. As shown in FIG. 1, the apparatus 100 includes a detecting unit 110, a control unit 120, an output unit 130, and a memory 140. The memory 140 is used for storing a plurality of audio settings. The detecting unit 110 is used for detecting a predetermined signal Sᵢ received by the display device (such as a monitor) to generate a detecting result DR. The control unit 120 is coupled to the detecting unit 110 for generating an audio signal Sₐ according to the detecting result DR. In this embodiment, the control unit 120 includes a decision unit 122 and an audio signal generator 124. The decision unit 122 is coupled to the memory 140 for choosing a particular audio setting DS from the plurality of audio settings stored in the memory 140 according to the detecting result DR. Please note that the particular audio setting DS can be a cue voice, a warning voice generated by machine, or a voice message recorded in advance, wherein the voice message is a human language corresponding to the operation status, the hardware status, and/or the program information of the display device (such as the utterance of “sound volume adjustment”, “restricted”, or “no signal”) and is used as the cue voice or the warning voice. Furthermore, the audio signal generator 124 is coupled to the decision unit 122 for generating the audio signal Sₐ according to the particular audio setting DS selected by the decision unit 122. Please note that the apparatus 100 is installed inside the display device in this embodiment of the present invention. The display device can have a built-in or an external loudspeaker 150. The loudspeaker 150 is coupled to the output unit 130 for selectively audibly reproducing the audio signal Sₐ, an audio stream S_{b}, or a mixed signal Sₐ+S_{b} by mixing the audio signal Sₐ and the audio stream S_{b}.

As shown in FIG. 1, the output unit 130 includes a switch 132 and a mixer 134. The mixer 134 is used for mixing the audio signal Sₐ and the audio stream S_{b} to generate the mixed signal Sₐ+S_{b}. The switch 132 selects to output the audio signal Sₐ to the loudspeaker 150 for audible reproduction when the output unit 130 receives the audio signal Sₐ (such as the warning voice) but not the audio stream S_{b} (such as an audio output of TV programs). The switch 132 selects to output the audio stream S_{b} to the loudspeaker 150 for audible reproduction when the output unit 130 receives the audio stream S_{b} (such as an audio output of TV programs) but not the audio signal Sₐ (such as the warning voice). When the output unit 130 receives the audio stream S_{b} (such as an audio output of TV programs) and the audio signal Sₐ (such as the warning voice) at the same time, the switch 132 selects to output the output of the mixer 134 (the mixed signal Sₐ+S_{b}) in one embodiment and selects to output the audio signal Sₐ in another embodiment, to the loudspeaker 150 for audible reproduction. Please note that detail of the operation of the output unit 130 described herein merely serves as an example and is not meant to limit the present invention.

Please continue referring to FIG. 1. Some examples in the following are used for illustrating operations of the apparatus 100 in the present invention. In one embodiment, it is assumed that a user uses an OSD interface to set the hardware status of a display device, such as a CRT monitor, an LCD monitor, an LCD TV, a digital TV, or an overhead projector. When the user starts to operate OSD settings (such as adjusting sound volume of a built-in loudspeaker), the detecting unit 110 detects the predetermined signal Sᵢ (a control signal triggered by the user, at this time being a sound volume adjustment signal) received by the display device, to generate a corresponding detecting result DR and to transmit the detecting result DR to the control unit 120. The decision unit 122 of the control unit 120 then selects a particular audio setting DS corresponding to the detecting result DR from the memory 140 and transmit the selected audio setting DS (such as issuing an utterance of “sound volume adjustment”) to the audio signal generator 124 according to the detecting result DR. Then, the audio signal generator 124 generates the desired audio signal Sₐ according to the selected audio setting DS and transmits the audio signal Sₐ to the output unit 130 for audibly reproducing the audio signal Sₐ through the loudspeaker 150 to inform users (issuing audible utterance of “sound volume adjustment”). Please note that when the loudspeaker 150 is reproducing the audio stream S_{b}, the switch 132 is used for selecting to audibly reproduce the audio signal Sₐ or to reproduce the mixed signal Sₐ+S_{b} according to the user's preference. Likewise, for other similar operations such as adjusting contrast, lightness, etc., the apparatus 100 according to the present invention can generate a corresponding audio signal Sₐ₊ that indicates the hardware status of the display device, and since they share the same operating principle, detailed explanation is not repeated herein.

Furthermore, for the purpose of parental control over restricted programs, for example, to avoid under-age viewing of pornographic or violent programs, a plurality of predetermined channel settings can be inputted by using a program menu setting of the display device (such as a TV), so that when the user selects certain channels, a predetermined signal Sᵢ received by the display device is detected by the detecting unit 110 to generate a detecting result DR and to transmit the detecting result DR to the control unit 120 if one of the predetermined channels is selected by the user. An example of said predetermined signal Sᵢ includes the system information, or SI, transmitted from the station along with the TV signal, which contains the rating information of the program being broadcast. The decision unit 122 of control unit 120 selects a predetermined audio setting DS corresponding to the detecting result DR from the memory 140 and transmit the particular audio setting DS (such as issuing audible utterance of “restricted”) to the audio signal generator 124 according to the detecting result DR. The audio signal generator 124 then generates the desired audio signal Sₐ according to the predetermined audio setting DS and transmits the audio signal Sₐ to the output unit 130, for audibly reproducing the audio signal Sₐ through the loudspeaker 150 to inform users (such as issuing audible utterance of “restricted”). Please note that the switch 132 is used for selecting to generate and then audibly reproduce the audio signal Sₐ or to generate and then audibly reproduce the mixed signal Sₐ+S_{b} according to a user's preference. The present invention will issue a warning sound if the user selects the predetermined channel. Therefore, it is helpful for TV channel classification.

If, however, a multimedia signal is not received or is interrupted after powering on or initializing a display device (such as a CRT monitor, an LCD monitor, an LCD TV, a digital TV, or an overhead projector), the detecting unit 110 will detect a status of not receiving the multimedia signal or signal interruption to generate a detecting result DR and to transmit the detecting result DR to the control unit 120. The decision unit 122 of the control unit 120 then selects a particular audio setting DS corresponding to the detecting result DR from the memory 140 and transmits the particular audio setting DS (such as issuing audible utterance of “no signal”) to the audio signal generator 124 according to the detecting result DR. The audio signal generator 124 will generate the desired audio signal Sₐ according to the particular audio setting DS and transmit the audio signal Sₐ to the output unit 130 for audibly reproducing the audio signal Sₐ through the loudspeaker 150 to inform users (such as issuing audible utterance of “no signal”).

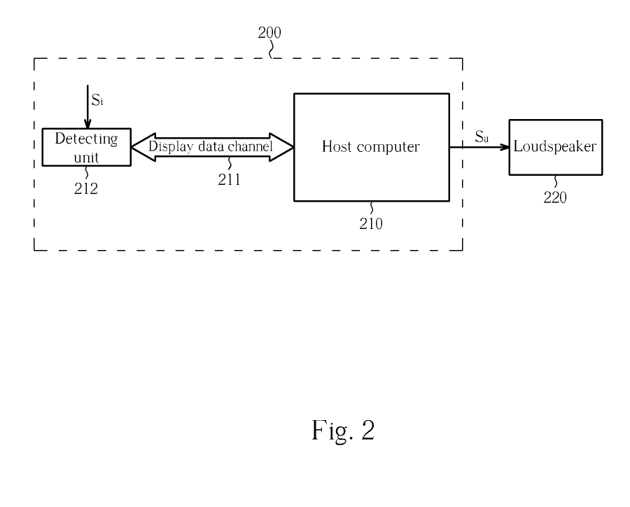

In the above embodiments, the apparatus 100 is installed in a display device with a built-in or an external loudspeaker 150. However, the mechanism for indicating a hardware status of a display device can be applied in a display device without a built-in or external loudspeaker, such as a monitor or an overhead projector. At this time, the detecting result of the detecting unit is transmitted to a host computer through a transmission interface (such as VGA or HDMI) having a display data channel, and the host computer is used for receiving the detecting result and generating the audio signal. Please refer to FIG. 2. FIG. 2 is a block diagram of an apparatus 200 for indicating an operation status, a hardware status, and/or program information of a display device by using a host computer 210 according to a second embodiment of the present invention. In this embodiment, operations of the control unit 120, the memory 140, and the output unit 130 shown in the first embodiment are all implemented by the host computer 210. The detecting unit 212 is installed inside the display device. Therefore, a detecting result is transmitted to the host computer 210 through a display data channel 211 when the detecting unit 212 detects a predetermined signal Sᵢ received by the display device. The host computer 210 will receive the detecting result, utilize audio equipments (such as a sound effect card or an audio processing chip) of the host computer 210 to generate the audio signal Sₐ, and will utilize a built-in or external loudspeaker 220 to audibly reproduce the audio signal Sₐ.

Hence, the display device is capable of indicating an operation hardware status (such as system setting, sound volume adjustment, or color adjustment), hardware status (such as input signal interruption), or program information (such as classified information) of the display device through an audio signal. Therefore, it is more convenient for users when using the display device with audio as an additional notice of hardware operation status.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for indicating hardware statuses of a display device, the method comprising:
detecting a predetermined signal received by the display device for generating a detecting result;
generating an audio signal according to the detecting result; and
outputting the audio signal.

2. The method of claim 1 further comprising:
storing a plurality of audio settings;
wherein the step of generating the audio signal comprises:
choosing a particular audio setting from the plurality of audio settings according to the detecting result; and
generating the audio signal according to the particular audio setting.

3. The method of claim 2, wherein one of the plurality of audio settings is a voice setting, and the audio signal generated according to the voice setting is a voice signal.

4. The method of claim 1, wherein the display device is coupled to a host computer, and the step of generating the audio signal according to the detecting result comprises using the host computer to receive the detecting result and to generate the audio signal.

5. The method of claim 4, wherein the step of detecting the predetermined signal received by the display device is performed by the display device, and the display device transmits the detecting result to the host computer through a display data channel (DDC).

6. The method of claim 1, wherein the predetermined signal is a user input triggered by a user interface of the display device, and the step of generating the detecting result comprises:
outputting the detecting result when detecting the user input.

7. The method of claim 1, wherein the predetermined signal is a multimedia signal, and the step of generating the detecting result comprises:
outputting the detecting result when detecting an interruption occurs in the multimedia signal.

8. The method of claim 1, wherein the determined signal is a program menu signal, and the step of generating the detecting result comprises:
outputting the detecting result when detecting that the program menu signal corresponds to a particular channel.

9. The method of claim 1, wherein the step of outputting the audio signal comprises:
providing a loudspeaker to audibly reproduce an audio stream; and
switching to audibly reproduce the audio signal when the loudspeaker is audibly reproducing the audio stream.

10. The method of claim 1, wherein the step of outputting the audio signal comprises:
providing a loudspeaker to audibly reproduce an audio stream;
mixing the audio stream with the audio signal to generate a mixed signal; and
using the loudspeaker to audibly reproduce the mixed signal.

11. An apparatus for indicating hardware statuses of a display device, the apparatus comprising:
a detecting unit used for detecting a predetermined signal received by the display device to generate a detecting result;
a control unit, coupled to the detecting unit, for generating an audio signal according to the detecting result; and
an output unit, coupled to the control unit, for outputting the audio signal.

12. The apparatus of claim 11 further comprising:
a memory, for storing a plurality of audio settings;
wherein the control unit comprises:
a decision unit, coupled to the memory, for choosing a particular audio setting from the plurality of audio settings according to the detecting result; and
an audio signal generator, coupled to the decision unit, for generating the audio signal according to the particular audio setting.

13. The apparatus of claim 12, wherein one of the plurality of audio settings is a voice setting, and the audio signal generated according to the voice setting is a voice signal.

14. The apparatus of claim 11, wherein the display device is coupled to a host computer, and the control unit uses the host computer to receive the detecting result and to generate the audio signal.

15. The apparatus of claim 14, wherein the display device is used for detecting the predetermined signal received by the display device, and the display device transmits the detecting result to the host computer through a display data channel (DDC).

16. The apparatus of claim 11, wherein the predetermined signal is a user input triggered by a user interface of the display device, and the detecting unit is used for outputting the detecting result when detecting the user input.

17. The apparatus of claim 11, wherein the predetermined signal is a multimedia signal, and the detecting unit is used for outputting the detecting result when detecting an interruption occurs in the multimedia signal.

18. The apparatus of claim 11, wherein the determined signal is a program menu signal, and the detecting unit is used for outputting the detecting result when detecting that the program menu signal corresponds to a particular channel.

19. The apparatus of claim 11, wherein the output unit provides a loudspeaker to audibly reproduce an audio stream; and
the output unit comprises:
a switch used for switching to audibly reproduce the audio signal when the loudspeaker is audibly reproducing the audio stream.

20. The apparatus of claim 11, wherein the output unit provides a loudspeaker to audibly reproduce an audio stream; and
the output unit comprises:
a switch used for switching to audibly reproduce the audio signal when the loudspeaker is audibly reproducing the audio stream; and
a mixer used for mixing the audio stream with the audio signal to generate a mixed signal, wherein the loudspeaker is used for audibly reproducing the mixed signal.
